(19) United States
(12) Patent Application Publication
(10) Pub. No.: US 2017/0263256 A1
(43) Pub. Date: Sep. 14, 2017

(54) SPEECH ANALYTICS SYSTEM

(71) Applicant: Uniphore Software Systems, Chennai (IN)

(72) Inventors: Umesh SACHDEV, Chennai (IN); Tarak TRIVEDI, Pune (IN)

(73) Assignee: Uniphore Software Systems, Chennai (IN)

(21) Appl. No.: 15/177,833

(22) Filed: Jun. 9, 2016

(30) Foreign Application Priority Data
Mar. 9, 2016 (IN) 201641008277

(51) Int. Cl. G10L 17/02; G10L 15/04; G10L 17/22; G10L 25/60

(52) U.S. Cl. CPC G10L 17/02; G10L 25/60; G10L 15/04; G10L 17/22

(57) ABSTRACT

A speech analytics system configured to detect an event is provided. The speech analytics system includes a graphical user interface configured to enable one or more users to upload one or more audio files. The speech analytics system also includes a rules configurator engine configured to receive and store a plurality of event rules. The plurality of event rules are provided by the one or more users via the graphical user interface. Further, the plurality of event rules stored in the rules configurator engine is reconfigurable by the one or more users. In addition, the speech analytics system includes an event detection module coupled to the rules configurator engine and configured to detect the event by processing the audio file. Lastly, the speech analytics system includes an event reporting module configured to notify the event to the one or more users.

### PRIORITY STATEMENT

The present application hereby claims priority under 35 U.S.C. §119 to Indian patent application number 201641008277 filed 9 Mar. 2016, the entire contents of which are hereby incorporated herein by reference.

### BACKGROUND

The invention relates generally to speech processing systems, and more particularly to a system and method for determining specific events during the course of a conversation.

Typically, organizations such as contact centers and business process outsourcing centers employ numerous service professionals having various skill sets to attend to queries posed by customers. Meeting the needs of the customers in a timely and efficient manner is paramount to a successful and profitable organization. Accordingly, it is often desirable to monitor call sessions that occur between customers and the service professionals, referred generally as agents, for supervising or training purposes. Therefore, customer-agent conversations are frequently recorded or otherwise monitored in controlled-environment facilities for monitoring quality of agents, managing customer experience and identifying potential opportunities for revenue generation.

Speech processing systems are usually employed for providing insights into the customer-agent conversation. Conventional methods for speech processing include recording the conversations and manually analyzing the recorded content offline. In some cases, the conversations are recorded and converted from audio format to text format. The text data is then further analyzed using various text analysis methods. However, these methods fall short of providing dynamic quality assurance since they do not address problems that arise real time during the interaction with customers. Also, the techniques described above are labor intensive tasks and may be susceptible to human error. Thus, the process becomes complex and the processing time also increases. Moreover, conversations as scenarios are dynamic and the above described systems do not have the capability to rapidly create and deploy new analytical models to cater to wide ranging conversations.

Therefore, there is a need for configurable speech analytics systems that identifies events in a conversation and provides efficient analytical solutions with improved accuracy and reduced processing time.

### SUMMARY

Briefly, according to one aspect of the invention a speech analytics system configured to detect an event is provided. The speech analytics system includes a graphical user interface configured to enable one or more users to upload one or more audio files. The speech analytics system also includes a rules configurator engine configured to receive and store a plurality of event rules. The plurality of event rules are provided by the one or more users via the graphical user interface. Further, the plurality of event rules stored in the rules configurator engine is reconfigurable by the one or more users. In addition, the speech analytics system includes an event detection module coupled to the rules configurator engine and configured to detect the event by processing the audio file. Lastly, the speech analytics system includes an event reporting module configured to notify the event to the one or more users.

In accordance with another aspect, a method for detecting an event is provided. The method includes enabling one or more users to upload one or more audio files. The method further includes receiving and storing a plurality of event rules. The plurality of event rules are provided by the one or more users and is reconfigurable by the one or more users. In addition, the method includes detecting the event by processing the audio file and notifying the event to the one or more users.

In accordance with yet another aspect, a computer system for detecting an event is provided. The computer system includes a graphical user interface configured to enable one or more users to upload one or more audio files. The computer system also includes a processor configured to receive and store a plurality of event rules. The plurality of event rules are provided by the one or more users via the graphical user interface and plurality of event rules in the tangible storage device is reconfigurable by the one or more users. The processor is further configured to detect the event by processing the audio file and notify the event to the one or more users.

### BRIEF DESCRIPTION OF THE FIGURES

FIG. 1 is a block diagram of an example embodiment of a speech analytics system adapted for detecting specific events, implemented according to aspects of the present technique;

FIG. 2 is a block diagram of an embodiment of a rules configurator engine implemented according to aspects of the present technique;

FIG. 3 is a flow chart illustrating one method in which an event is detected according to aspects of the present technique;

FIG. 4 and FIG. 5 are example screen shots of a graphical user interface implemented according to aspects of the present technique;

FIG. 6 is a screen shot of a graphical user interface illustrating a live call, implemented according to aspects of the present technique;

FIG. 7 is a screen shot of a graphical user interface illustrating job schedule and re-process features implemented according to aspects of the present technique;

FIG. 8 is a screen shot of a graphical user interface illustrating a supervisor dashboard implemented according to aspects of the present technique;

FIG. 9 is a screen shot of a graphical user interface illustrating a group's performance implemented according to aspects of the present technique;

FIG. 10 and FIG. 11 are screen shots of a graphical user interface illustrating scores assigned to a plurality of business rules, implemented according to aspects of the present technique; and

FIG. 12 is a block diagram of an embodiment of a computing device executing modules of a speech analytics system, in accordance with an embodiment of the present invention.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The speech analytics system described below enables integrated mining and analytics solutions, which often assists organizations, such as contact centers, for example, to identify critical events that occur from time to time. In order to accurately identify such events, a configurable rule configurator engine is used along with an event detection module. By identifying critical events through flexible rule configuration, the organization achieves business goals and realizes significant benefits in terms of increase in quality, customer satisfaction, cost savings, and revenue generation. The different aspects of the present technique are described in further detail below.

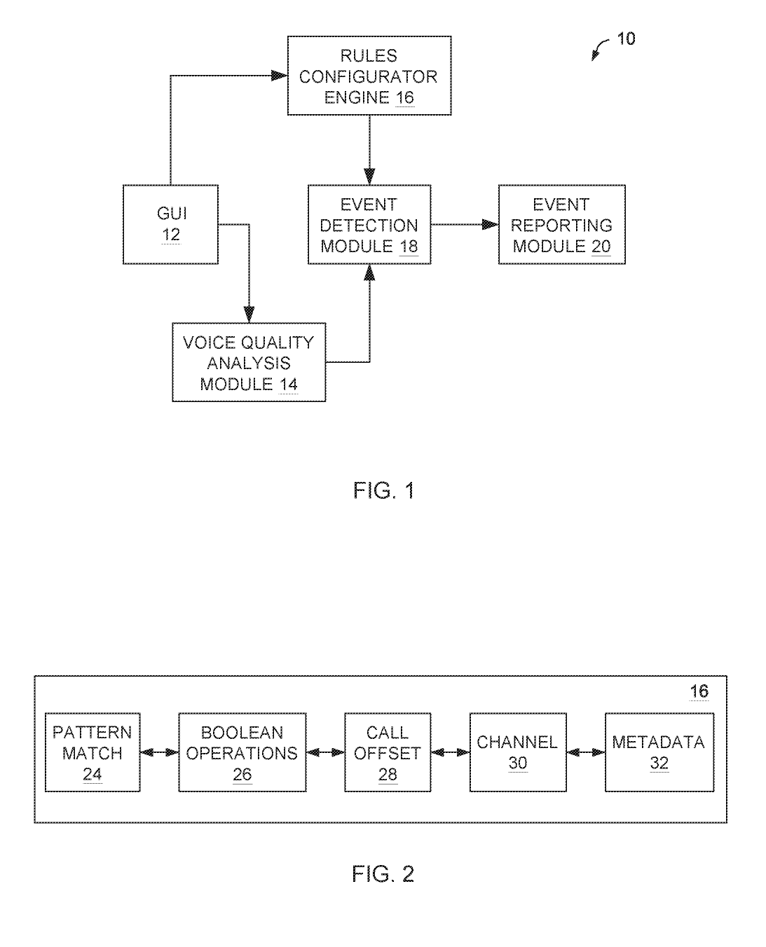

FIG. 1 is a block diagram of an example embodiment of a speech analytics system adapted for detecting specific events, implemented according to aspects of the present technique. For simplicity, the present technique is described below with reference to a contact center. However, it should be understood by one skilled in the art that the contact center environment is used for exemplary purposes only and aspects of the present technique can be applied to any organization that employ speech analytics systems. Speech analytics system 10 includes a Graphical user interface (GUI) 12, a voice quality analysis module 14, a rule configurator engine 16, an event detection module 18 and event reporting module 20. Each block is explained in further detail below.

Graphical user interface (GUI) module 12 is configured to facilitate one or more users to access the speech analytics system 10. As used herein, the one or more users include data analysts or customer service professionals referred herein as “agent” or a “supervisor”. A supervisor typically manages a group of agents. GUI 12 enables the agents to upload one or more audio files that requires analysis. The audio files comprise voice recordings of customer-agent interaction. In one embodiment, the audio files are in stereo format.

Voice quality analysis module 14 is configured to improve the quality of the voice recording by applying various audio-filtering applications. In one embodiment, operations such as noise removal, amplitude normalization, DC shift correction and spike correction are performed to enhance the quality of the audio file.

Rules configurator engine 16 is configured to receive a plurality of event rules based on which an event can be detected. In one embodiment, the graphical user interface is used to add, edit or modify, the plurality of event rules. In one embodiment, the event rule comprises Boolean operators and/or objects. Examples of Boolean operators include AND, OR, NOR and NAND. Examples of objects include standard business rules or audio attributes or meta-data or any combination thereof. Meta data usually refers to call duration, speech overlap, silence, etc.

Event detection module 18 is coupled to the rules configurator engine 16 and is configured to detect an event by processing the audio file. As used herein, an event is defined as an occurrence of an incident that may affect an organization's performance. In one embodiment, the audio file is divided into a plurality of segments and each segment is analyzed sequentially.

Event reporting module 20 is configured to notify a detected event to the one or more users. In one embodiment, the event reporting module 20 is configured to categorize the detected event into one or more categories. For example, a call-time based event is detected during a specific call segment namely call opening, call middle segment and call closing. These events can be accurately identified with the help of the event rules. For example, the statement such as “Thank you for calling” occurring in a call could be at call opening or at call closing or both. Such an event is termed as a call-time based event.

Another example of an event is a query-response pair events where a query from one party is followed by a response from another party in that sequence within a given time period. These events can be accurately identified with the help of the event rules. For example, a query from a service professional could be “Shall I confirm the transaction?” occurring in a call at any time during the call followed by an immediate reaction or response from a customer could be “Yes please confirm it”, can be accurately identified through event rules configuration.

Sequence based events are those events where script adherence is the prime objective. This means that a service professional would say specific statements in a particular order. These events can be accurately identified with the help of the event rules. Similarly, reaction based events are those events where one either party exhibits a reaction which leads to a sentiment (of either polarity) in a call for a given call segment. These are response or reaction based events typically from the customer. These events can be accurately identified with the help of the event rules configurator.

Meta-data based events are those events where meta-data in a call is identified which leads to triggering specific events. These are silence, speech-pauses or speech overlaps or call duration-based events. These events can be accurately identified with the help of the event rules configurator. Urgency based events are those events where certain keywords are identified that trigger specific actions. These are risk and compliance events, security or fraud based events or an action event that requires immediate attention. These events can be accurately identified with the help of the event rules configurator and are generally limited to specific keywords.

Nested events are those events where one event rule is nested inside a parent event rule. These could be a combination of events where one event is detected and triggered within another. These events can be accurately identified with the help of the event rules configurator.

The various events described above are identified by configuring the rules configurator engine 16 with a plurality of event rules. The manner in which the rules configurator engine 16 operates is described in further detail below.

FIG. 2 is a block diagram of one embodiment of a rules configurator engine implemented according to aspects of the present technique. The rules configurator engine 16 receives a plurality of event rules that are provided by one or more users, based on a business requirement. In the illustrated example, the one or more users refer to either agents or supervisors. The manner in which the rules configurator engine 16 operates is described in further detail below.

Rules configurator engine 16 enables an agent or a supervisor or an analyst, to add and/or modify a plurality of event rules. In one embodiment, the plurality of events may correspond to combinations of various components. In the illustrated embodiment, the components of the rules configurator engine 16 comprises pattern match 24, Boolean operators 26, call offset selection 28, channel selection 30 and metadata 32. Each component is described in further detail below.

Pattern match 24 refers to event rules that are based on speech that may contain or do not contain several defined keywords. In one embodiment, the keywords are identified to evaluate a call quality. Boolean operators 26 are based on event rules that combine several keywords in pattern match 24 using one or more Boolean operators 26. The call offset selection component 28 defines event rules that are based on the span of a call. For example, event rules can be defined during an opening span of a call, or a closing span of a call or any other time as desired.

Channel selection component 30 is configured to map the keywords to an agent channel or a customer channel. An agent channel typically focuses on the agent's interaction with a customer. By monitoring a manner in which an agent interacts with a customer, a supervisor is equipped to evaluate the agents within the team more effectively. Metadata 32 comprises information regarding various attributes of the call. Examples include call duration, speech overlap, silence, talkover, etc.

Based on components configured above, the rules configurator engine 16 is configured to define a plurality of event rules that are used to identify an event. For example, in a contact center, event rules could be related to customer escalation, speech-pause, negative sentiment, good call opening, potential customer churn, etc. An example event rule with respect to customer escalation is described below.

In a contact center organization, a customer escalation is defined as an event when a customer query is transferred to a senior supervisor. This escalation is generally due to increasing customer dissatisfaction or unclear solution offered by the agent. Typically, such a situation arises when the service professional is unable to calm, convince, assure or satisfy the customer on live call. For such an event an example rule is defined below:

IF KEYWORDS (value=“senior” OR “team lead” OR “quality analyst” OR “manager” OR “boss” OR “experienced person” OR “Technical person” OR “head” OR “chief” OR “senior executive” OR “somebody” OR “someone else” OR “anyone else”) AND TIME>10 seconds AND SENTIMENT=“NEGATIVE”

The event rules configured in the rules configurator engine 16 is used while analyzing each customer-agent interaction. The manner in which an event is detected in described in further detail below.

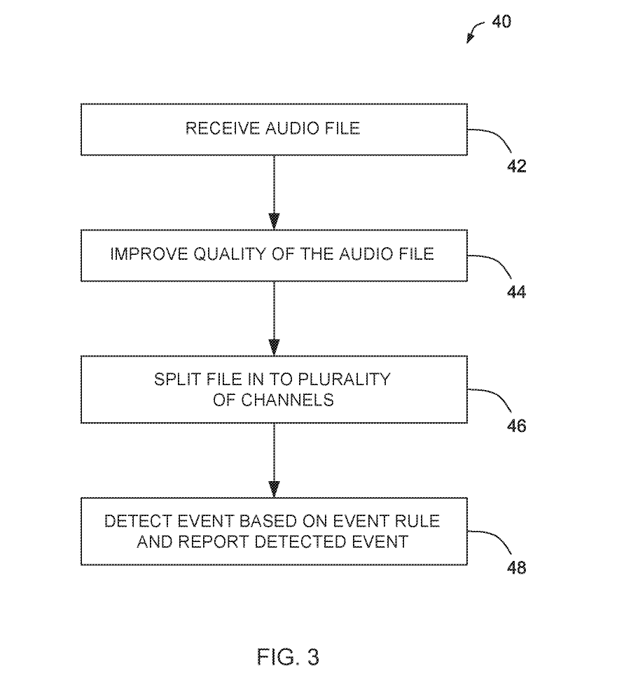

FIG. 3 is a flow chart describing one method by which an event is detected during a two-party interaction. For exemplary purposes only, the event detection method 40 is described with reference to a customer-agent interaction that occurs typically in a contact center. Each step in the event detection method is described in further detail below.

At step 42, an audio file is received. In one embodiment, the audio file is in a stereo format. The audio file comprises an audio recording of a customer-agent interaction.

At step 44, the quality of the audio file is improved. In one embodiment, a number of voice enhancing techniques are applied on the audio file to enhance the quality of the audio file. Examples of voice enhancing techniques include noise removal, amplitude normalization, DC shift correction, spike correction and the like.

At step 46, the audio file is split into a plurality of portions. In one embodiment, a file splitter module is used to split the audio into chunks (or blocks of audio data). The number of chunks that the audio file is split into may be pre-selected. For example, each chunk may be about 10 seconds long.

At step 48, for each chunk of audio data, the event rules defined in the rules configurator engine is applied. The audio chunk is evaluated to identify if any event defined in the rules configurator engine is present. Upon identifying a match of any one of the rules, an event is detected. The detected event is then recorded and displayed using the graphical user interface.

As described above, the graphical user interface enables the agent and/or the supervisor the flexibility to add or modify a plurality of event rules. Also, the graphical user interface provides the supervisor with real-time data regarding various parameters of his teams, for example, performance of each agent, events detected, and the like. In a further embodiment, the graphical user interface enables a supervisor to add and modify a score to each business rule. Further, the supervisor may also add a weight to each score, depending on the importance of the business rule to each organization. Various screen shots of the graphical user interface is described in detail below.

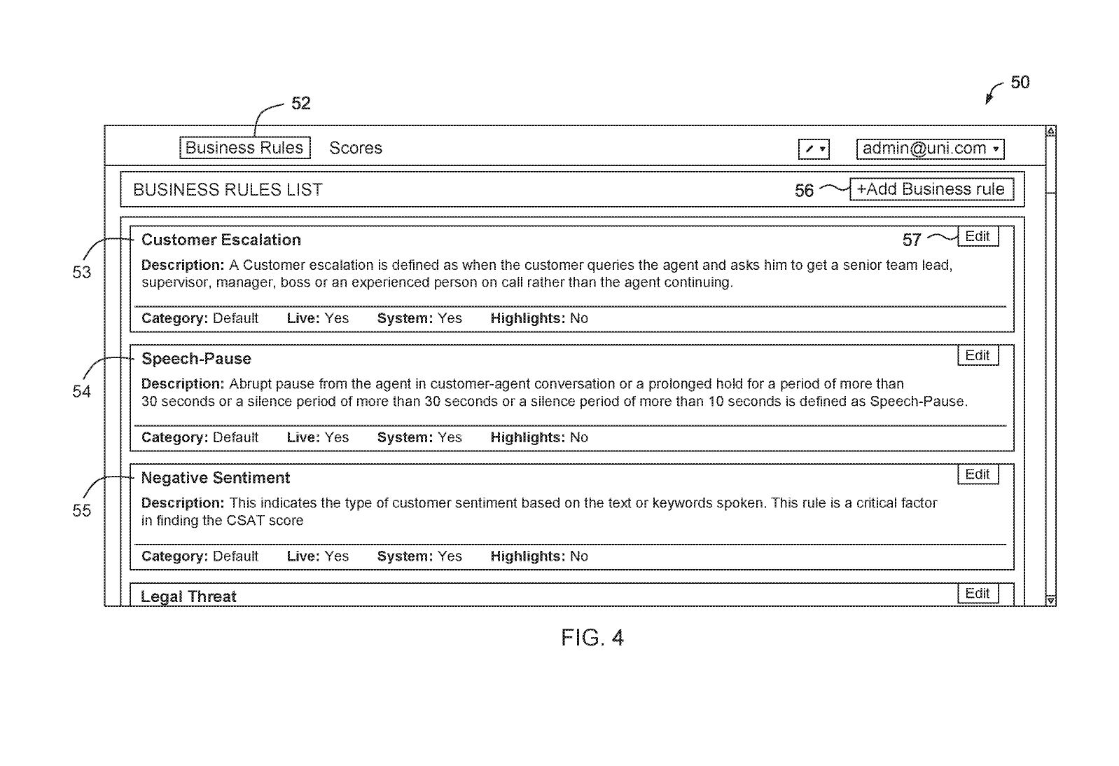

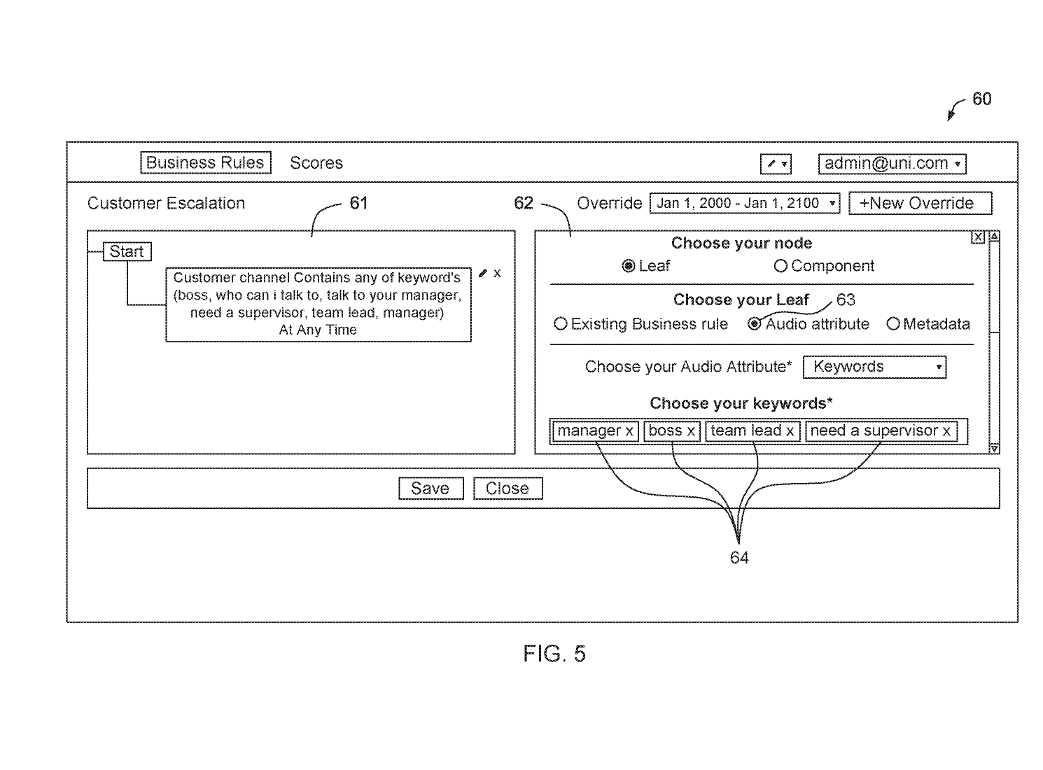

FIG. 4 and FIG. 5 are example screen shots of a graphical user interface 50 and 60 implemented according to aspects of the present technique. Graphical User Interface 50 includes business rule tab 52, which lists out the various business rules for a particular organization, such as, for example, a contact center. The business rules are listed in field 53, 54 and 55. Each business rule is provided with a description and some various default attributes. The “Add Business Rule” tab 56 is provided to enable the addition of new business rules as desired. Further, under each rule, an “Edit” tab 57 is provided to modify existing business rules.

FIG. 5 is another screen shot of the graphical user interface 60 that enables the addition of keywords. As shown, the various keywords that are defined under “customer escalation” tab are show in field 61. In field 62, a set of keywords as shown by 64 can be added under audio attribute 63. Thus, the rules configurator engine provides the flexibility to define each business rule.

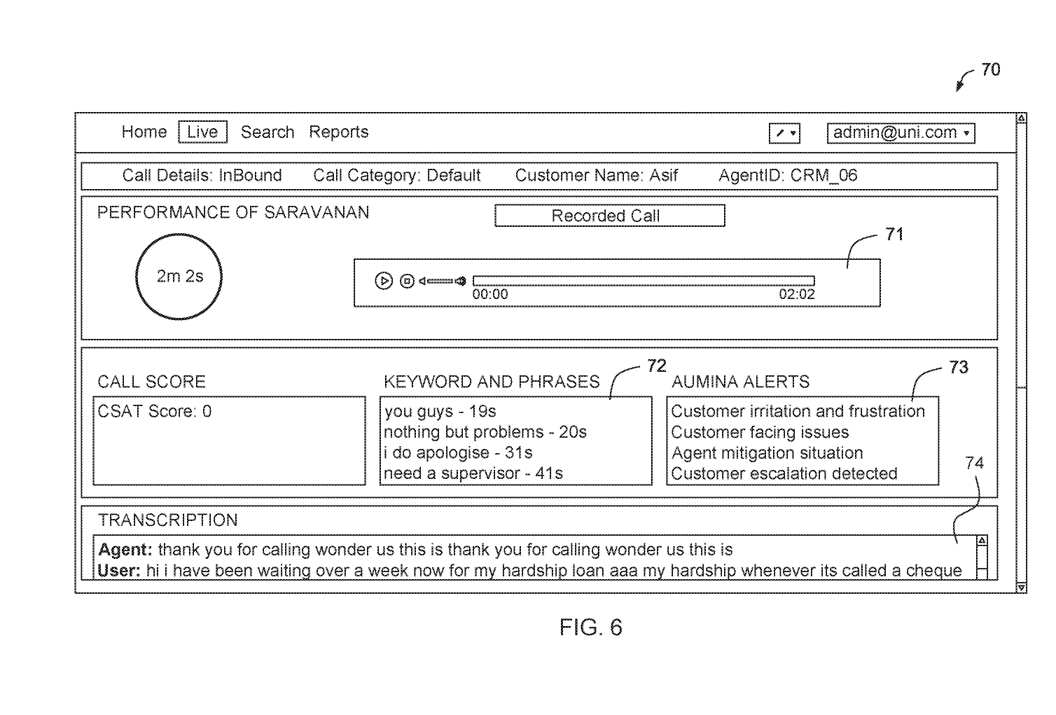

FIG. 6 is a screen shot of a graphic user interface 70 illustrating a live call, implemented according to aspects of the present technique. The progress of the call is displayed in field 71. As the call progresses, the keywords and phrases that are detected are displayed in field 72. It may be noted that the time at which a keyword and/or a phrase is detected is also provided. Based on the detected keywords, events that are detected are displayed in field 73. A complete transcript of the call is also displayed in field 74.

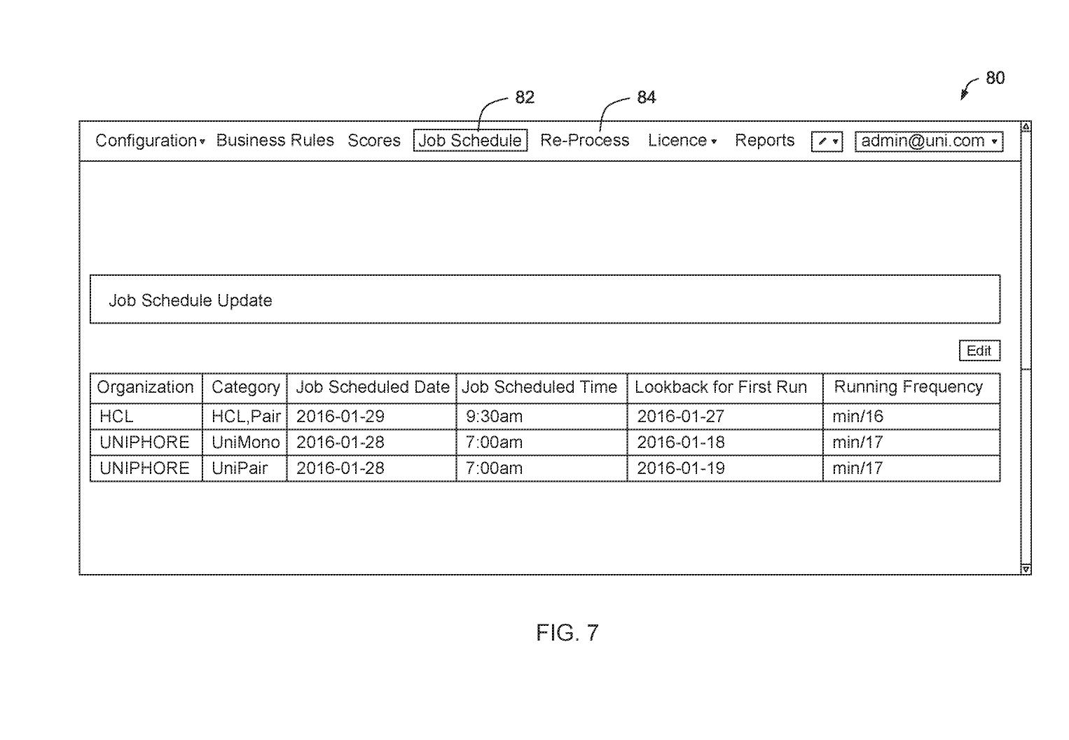

FIG. 7 is a screen shot of a graphic user interface 80 illustrating job schedule 82 and re-process 84 features implemented according to aspects of the present technique. The job schedule tab 82 enables a supervisor to schedule a specific date and time to execute processing of batch-mode audio data. The data gets refreshed automatically based on the set running frequency. The re-process tab 84 allows the administrator to view various processing details such as the Process Date, User Name, Organization, Category, Call Start Date, Call End Date etc. without the need of checking the backend system. In addition, all process details can be viewed in a simple user-friendly manner. Further, the administrator can filter the details based on various dropdowns provided at the bottom of the screen to drill down into a particular call using a particular business rule and so on.

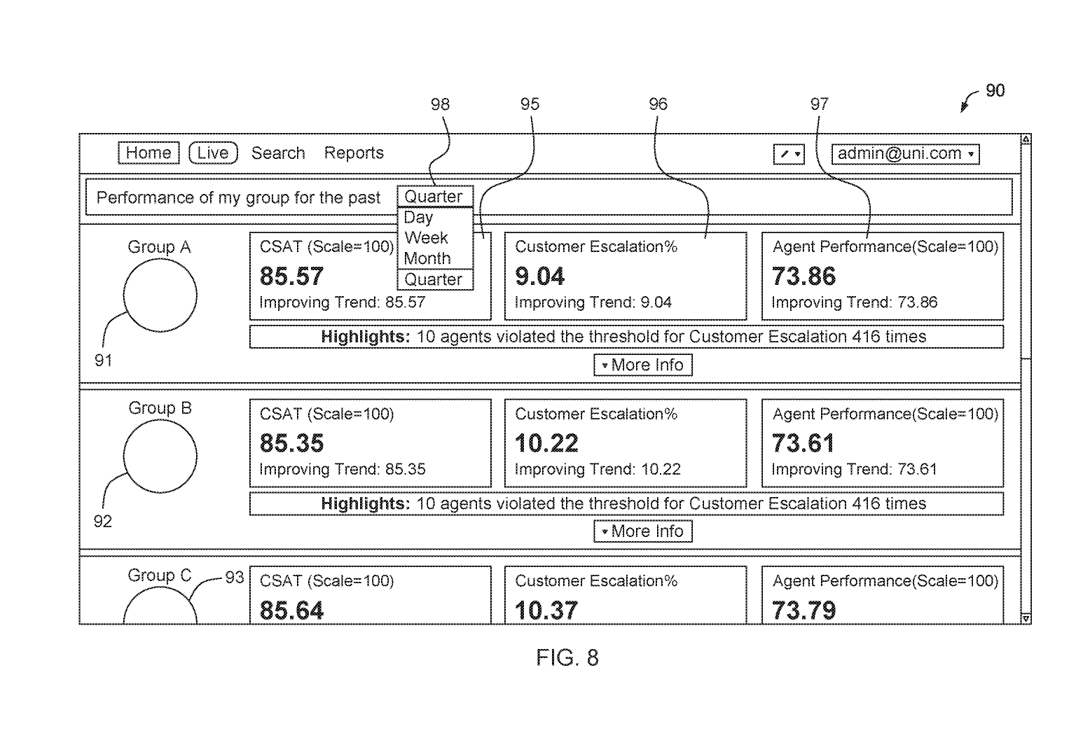

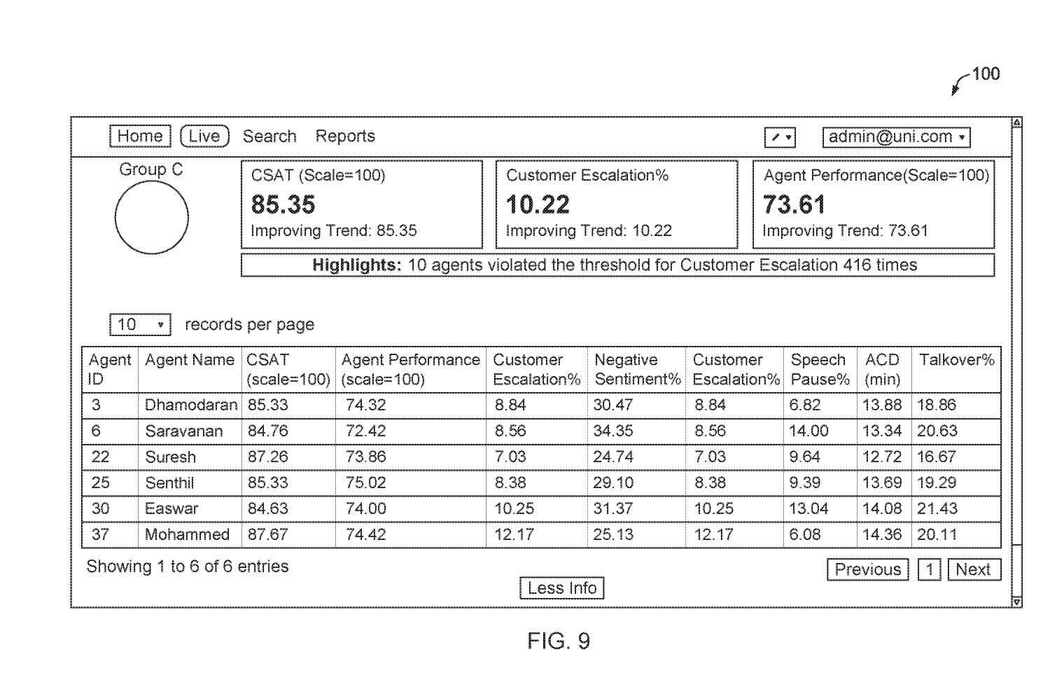

FIG. 8 is a screenshot of a graphical user interface 90 that provides a snap shot of a plurality of agents working a team. The teams are identified as Group A, Group B and Group C as referred by reference numerals 91-93. Each group's performance is visually represented in the form of tiles such as CSAT score 95, a percentage of customer escalation 96 and an agent performance score 97. It may be noted that the tiles can be customized according to the supervisor's requirements. In addition, the supervisor may select the performance of a particular group for a particular period from a dropdown list 98 consisting of options such as Day, Week, Monthly, Quarter, etc. Further by clicking on any group, say for instance, Group C as shown in FIG. 9, the supervisor can drill down and monitor various performance parameters such as ACD, % etc. which are used to calculate the Agent Performance Scores for each of the agents within the group.

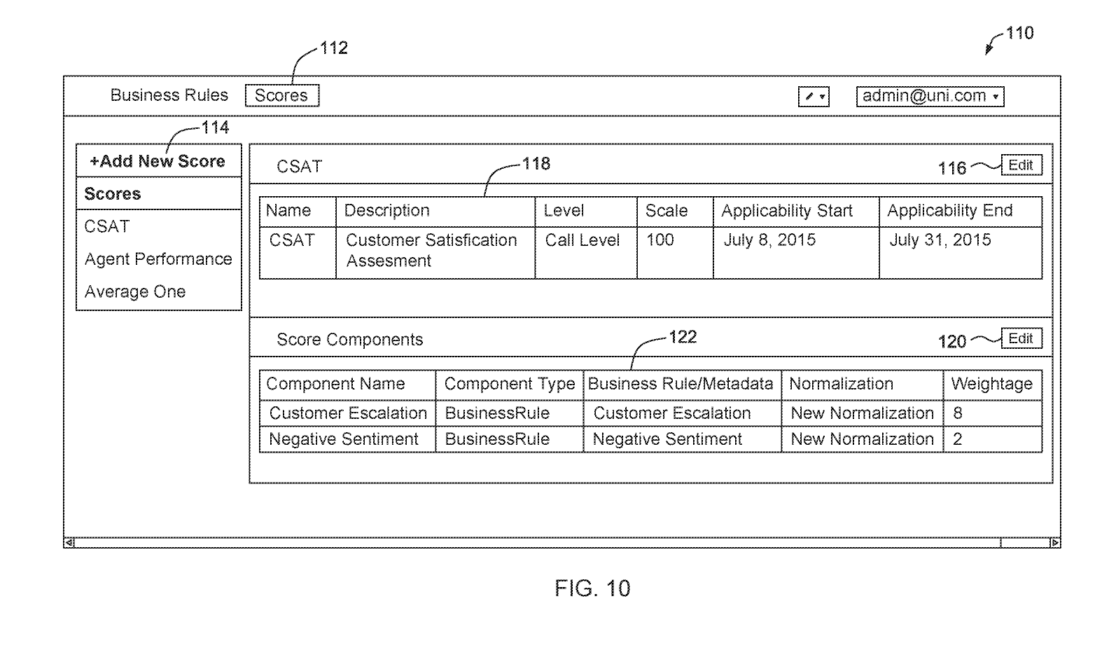

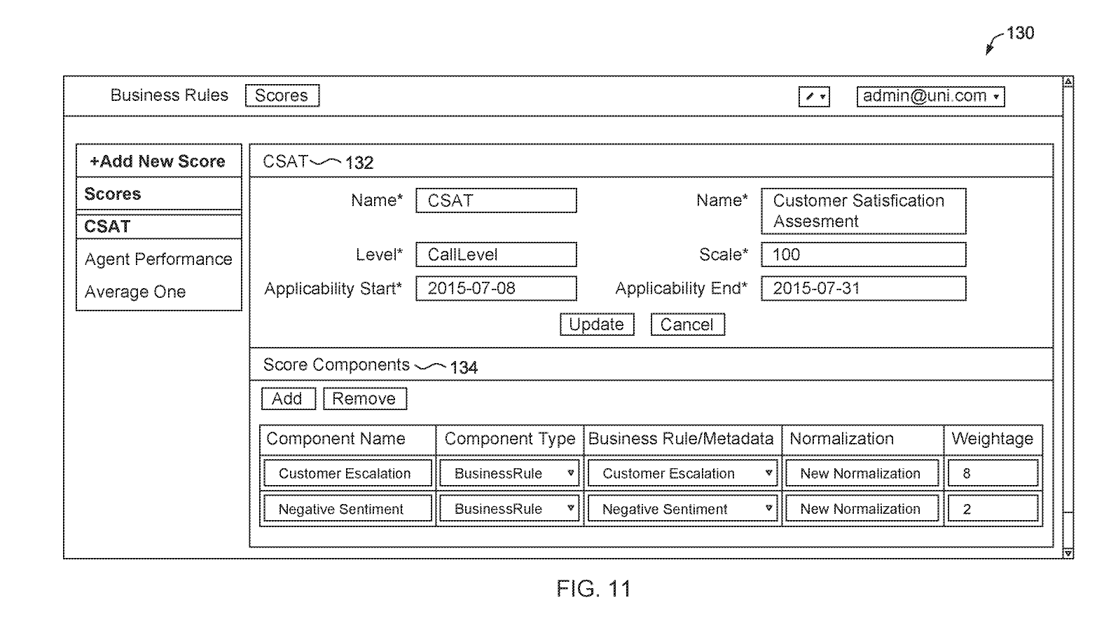

FIG. 10 and FIG. 11 are screen shots of a graphical user interface 110 and 130 illustrating the manner in which a supervisor may add or modify scores, implemented according to aspects of the present technique. GUI 110 comprises a scores tab 112 that enables the supervisor to add scores, as shown in FIG. 9. For each rule, a corresponding description, scale and applicability start and end date is provided as shown in tab 118, which are also editable as shown by edit tab 116.

Each rule also has a plurality of components as shown by referral numeral 122. In one embodiment, each component has a corresponding weightage. For example, customer escalation has a weightage of 8 and negative sentiment has a weightage of 2. The weightages can be edited using the edit tab 120.

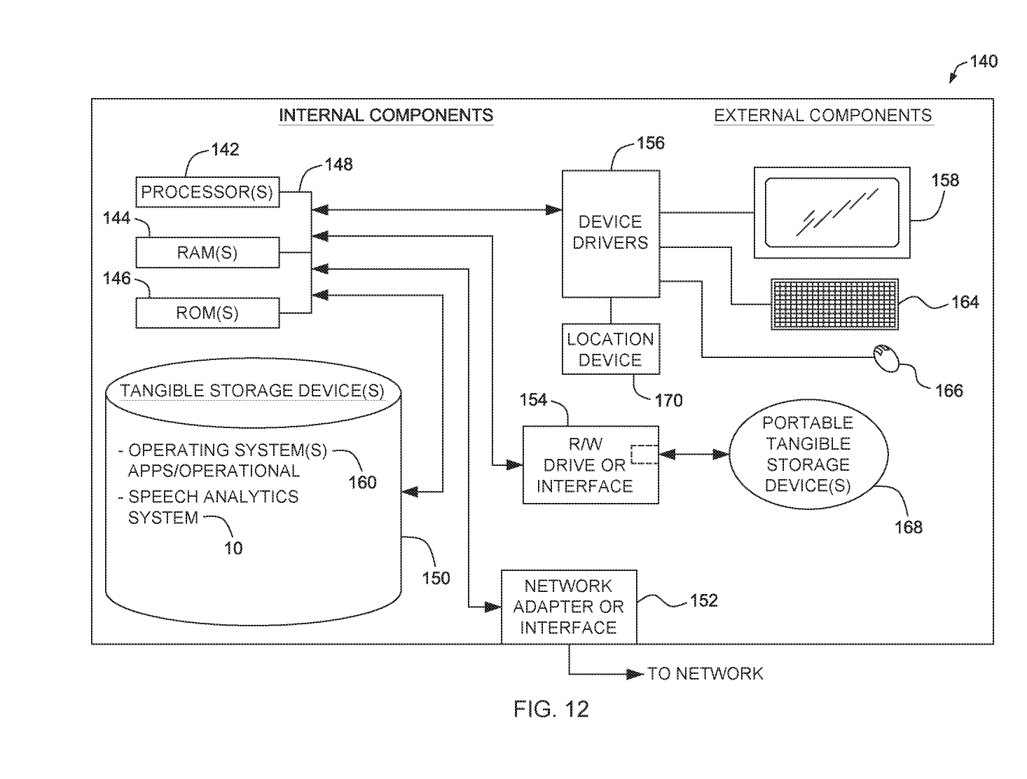

The modules of the speech analytics system described herein are implemented in computing devices. One example of a computing device 140 is described below in FIG. 12. The computing device comprises one or more processor 142, one or more computer-readable RAMs 144 and one or more computer-readable ROMs 146 on one or more buses 148. Further, computing device 140 includes a tangible storage device 150 that may be used to execute operating systems 160 and speech analytics system 10. The various modules of the speech analysis system 10 including the rule configuration engine 16, event detection module 18 and event reporting module 20 can be stored in tangible storage device 150. Both, the operating system and the speech analytics system are executed by processor 142 via one or more respective RAMs 144 (which typically include cache memory).

Examples of storage devices 150 include semiconductor storage devices such as ROM 146, EPROM, flash memory or any other computer-readable tangible storage device that can store a computer program and digital information.

Computing device also includes a R/W drive or interface 154 to read from and write to one or more portable computer-readable tangible storage devices 168 such as a CD-ROM, DVD, memory stick or semiconductor storage device. Further, network adapters or interfaces 152 such as a TCP/IP adapter cards, wireless wi-fi interface cards, or 3G or 4G wireless interface cards or other wired or wireless communication links are also included in computing device.

In one embodiment, the speech analytics system 10, which includes the rule configuration engine 16, event detection module 18 and event reporting module 20, can be downloaded from an external computer via a network (for example, the Internet, a local area network or other, wide area network) and network adapter or interface152.

Computing device further includes device drivers 156 to interface with input and output devices. The input and output devices can include a computer display monitor 158, a keyboard 164, a keypad, a touch screen, a computer mouse 166, and/or some other suitable input device. The graphical user interface 12 is displayed on monitor 158 and a user may provide data to the speech analytics system 10 via any one of the input devices.

The above-described techniques thus allow an analyst or a supervisor and/or an agent to rapidly develop and deploy new business rules with weighted scores or create new analytical models and simulate them on audio data. Such rapid change and deployment allows a user, with even minimum computer programming knowledge to use the techniques described herein, to analyze and understand deep insights from the data with relation of customer satisfaction, churn propensity, agent quality and performance etc.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A speech analytics system configured to detect an event, the speech analytics systems comprising:
a graphical user interface configured to enable one or more users to upload one or more audio files;
a rules configurator engine configured to receive and store a plurality of event rules; wherein the plurality of event rules are provided by the one or more users via the graphical user interface; wherein plurality of event rules stored in the rules configurator engine is reconfigurable by the one or more users;
an event detection module coupled to the rules configurator engine and configured to detect the event by processing the audio file; and
an event reporting module configured to notify the event to the one or more users.

2. The speech analytics system of claim 1, wherein each event rules comprise a corresponding plurality of keywords, call metadata and/or Boolean operators.

3. The speech analytics system of claim 2, wherein the keywords, call metadata and/or Boolean operators are configured to be added, deleted or modified.

4. The speech analytics system of claim 1, wherein each event rule comprises a plurality of components, wherein the plurality of components is reconfigurable.

5. The speech analytics system of claim 4, wherein each component of a corresponding event rule is assigned a weightage.

6. The speech analytics systems of claim 1, wherein the event detection module is configured to divide the audio file into a plurality of portions and wherein the event detection module is configured to process each portion of the audio till an event is detected.

7. The speech analytics system of claim 6, wherein each portion is processed sequentially.

8. The speech analytics system of claim 1, wherein the event reporting module is configured to categorize the detected event into one or more categories.

9. The speech analytics system of claim 8, wherein the event reporting module is configured to categorize the detected event into categories such as call-time based event, query-response pair events, sequence based events, meta-data based events, nested events or combinations thereof.

10. The speech analytics system of claim 1, further comprising a voice quality module configured to enhance a quality of the audio file.

11. A method for detecting an event using speech analytics, the method comprising:
enabling one or more users to upload one or more audio files;
receiving and storing a plurality of event rules; wherein the plurality of event rules are provided by the one or more users and is reconfigurable by the one or more users;
detecting the event by processing the audio file; and
notifying the event to the one or more users.

12. The method of claim 11, wherein each event rule comprises a plurality of components, and wherein the plurality of components is reconfigurable.

13. The method of claim 12, further comprising assigning a weightage to each component of a corresponding event rule.

14. The method of claim 11, further comprising dividing the audio file into a plurality of portions and processing each portion of the audio sequentially till an event is detected.

15. The method of claim 11, further comprising categorizing the detected event into one or more categories.

16. The method of claim 15, wherein categorizing the detected event into categories such as call-time based event, query-response pair events, sequence based events, meta-data based events, nested events or combinations thereof.

17. The method of claim 11, further comprising enhancing a quality of the audio file.

18. A computer system for detecting an event, the computer system comprising:
a graphical user interface configured to enable one or more users to upload one or more audio files; and
a processor configured to:
receive and store a plurality of event rules; wherein the plurality of event rules are provided by the one or more users via the graphical user interface;
wherein plurality of event rules stored in the tangible storage device is reconfigurable by the one or more users;
detect the event by processing the audio file; and
notify the event to the one or more users.

19. The computer system of claim 18, wherein each event rules comprise a corresponding plurality of keywords, call metadata and/or Boolean operators.

20. The computer system of claim 19, wherein the keywords, call metadata and/or Boolean operators are configured to be added, deleted or modified.
